(19) United States
(12) Patent Application Publication
(10) Pub. No.: US 2026/0012827 A1
(43) Pub. Date: Jan. 8, 2026

(54) CELL DISCONTINUOUS COMMUNICATIONS WITH MEASUREMENT OCCASIONS

(71) Applicant: QUALCOMM Incorporated, San Diego, CA (US)

(72) Inventors: Diana MAAMARI, San Diego, CA (US); Ahmed Attia ABOTABL, San Diego, CA (US); Huilin XU, Temecula, CA (US)

(21) Appl. No.: 18/761,719

(22) Filed: Jul. 2, 2024

(51) Int. Cl. H04W 24/10; H04L 5/00; H04W 76/28

(52) U.S. Cl. CPC H04W 24/10; H04L 5/0048; H04W 76/28

(57) ABSTRACT

Certain aspects of the present disclosure provide techniques for interaction between cell discontinuous communications and measurement occasions. An example method for wireless communications by an apparatus includes obtaining a first configuration for cell discontinuous communications, wherein the first configuration indicates (i) a first time period during which communication via a first cell is allowed and (ii) a second time period during which communication via the first cell is unavailable; obtaining a second configuration that indicates one or more measurement occasions for reference signal measurement; obtaining an indication of one or more rules for reference signal measurement during a measurement occasion that overlaps in time with a time period during which communication via the first cell is allowed; and communicating with a network entity based on the first configuration, the second configuration, and the one or more rules.

### FIELD OF THE DISCLOSURE

Aspects of the present disclosure relate to wireless communications, and more particularly, to techniques for interaction between cell discontinuous communications and measurement occasions.

### DESCRIPTION OF RELATED ART

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communications by an apparatus. The method includes obtaining a first configuration for cell discontinuous communications, wherein the first configuration indicates (i) a first time period during which communication via a first cell is allowed and (ii) a second time period during which communication via the first cell is unavailable; obtaining a second configuration that indicates one or more measurement occasions for reference signal measurement, wherein the one or more measurement occasions comprise at least one first measurement occasion that overlaps in time with the first time period and at least one second measurement occasion that overlaps in time with the second time period; obtaining an indication of one or more rules for reference signal measurement during a measurement occasion that overlaps in time with a time period during which communication via the first cell is allowed; and communicating with a network entity based on the first configuration, the second configuration, and the one or more rules.

Another aspect provides a method for wireless communications by an apparatus. The method includes sending a first configuration for cell discontinuous communications, wherein the first configuration indicates (i) a first time period during which communication via a first cell is allowed and (ii) a second time period during which communication via the first cell is unavailable; sending a second configuration that indicates one or more measurement occasions for reference signal measurement, wherein the one or more measurement occasions comprise at least one first measurement occasion that overlaps in time with the first time period and at least one second measurement occasion that overlaps in time with the second time period; sending an indication of one or more rules for reference signal measurement during a measurement occasion that overlaps in time with a time period during which communication via the first cell is allowed; and communicating with a user equipment based on the first configuration, the second configuration, and the one or more rules.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment (UE).

FIGS. 4A, 4B, 4C, and 4D depict various example aspects of data structures for a wireless communications network.

FIG. 5 depicts an example arrangement of a cell discontinuous transmission cycle and a measurement cycle over time.

FIG. 6 depicts example schemes for interactions between measurement occasions and cell discontinuous communications.

FIG. 7 depicts a process flow for signaling related to cell discontinuous communications with measurement occasions.

FIG. 8 depicts a method for wireless communications.

FIG. 9 depicts another method for wireless communications.

FIG. 10 depicts aspects of an example communications device.

FIG. 11 depicts aspects of an example communications device.

### DETAILED DESCRIPTION

Aspects of the present disclosure provide apparatuses, methods, processing systems, and computer-readable mediums for interaction between cell discontinuous communications and measurement occasions.

In certain wireless communications systems (e.g., 5G New Radio (NR) systems and/or any future wireless communications system), a user equipment (UE) may be configured to perform and report certain communication channel measurements (e.g., radio resource measurements) to a network entity (e.g., a base station). The channel measurements may be intra-frequency, inter-frequency, and/or inter-system. Assuming the UE is in communication with the network entity via a specific carrier frequency of a serving cell, the intra-frequency measurements refer to channel measurements being at the same carrier frequency as the serving cell; the inter-frequency measurements refer to channel measurements being at a different frequency as the serving cell; and inter-system measurements refer to channel measurements using a different radio access technology (RAT) used to communicate with the serving cell (e.g., Evolved Universal Terrestrial Radio Access (E-UTRA)).

In some cases, a UE may be capable of tuning its radio frequency (RF) transceiver to a single carrier frequency for communications or measurements. For example, the UE may be incapable of communicating at a carrier frequency while obtaining inter-frequency measurements at a different carrier frequency. Thus, in order to obtain certain measurements (e.g., certain intra-frequency, inter-frequency, and/or inter-system measurements), the UE may be allocated sufficient time to tune its RF transceiver to the target carrier frequency for measurements of a neighboring cell, complete the measurements at the target carrier frequency, and then re-tune its RF transceiver to the original carrier frequency of the serving cell. A measurement gap may include the time allocated for transceiver tuning and obtaining intra-frequency, inter-frequency, and/or inter-system channel measurements. During a measurement gap, the UE may not be expected (or scheduled) to communicate other traffic or signaling. Accordingly, a measurement gap may interrupt certain communications for the UE, as further discussed herein.

In certain cases, a UE may be equipped with an additional RF transceiver to obtain measurements. However, sufficient time may be allocated to configure the additional RF transceiver for measurements and/or communications. For example, interruption lengths (sometimes referred to as visible interruption lengths (VILs)) may be allocated before and after a measurement length (e.g., a measurement occasion) used for obtaining the measurements at the target carrier frequency via the additional RF transceiver. As an example, each of the interruption lengths may have a duration of 1 millisecond (ms). The combined gap of the interruption lengths and corresponding measurement length arranged between the interruption lengths may be referred to as a network controlled small gap (NCSG). During the measurement length, the UE may be allowed to communicate via a carrier frequency of a serving cell; whereas during the interruption lengths, the UE may not be expected (or scheduled) to communicate other traffic or signaling via the carrier frequency of the serving cell. Accordingly, the interruption lengths associated with a measurement length may interrupt certain communications for the UE, as further discussed herein.

In certain cases, a network entity (e.g., a base station) may communicate with a UE via a cell, which may correspond to a specific carrier frequency and/or coverage area of one or more transmission-reception points (TRPs) of the network entity. In order to implement energy savings for wireless communications, the network entity may configure certain time periods where a cell is active and non-active (e.g., inactive) for downlink and/or uplink traffic. For example, during a cell discontinuous transmission (DTX) cycle, there is an active time period during which the network entity can transmit downlink traffic via the cell; and there is a non-active time period during which the network entity refrains from transmitting certain downlink traffic via the cell. The network entity may inform the UE of the cell DTX cycle, which may recur with a periodicity upon activation of the cell DTX cycle. In response to the cell DTX cycle being activated, the UE may also refrain from monitoring for certain downlink traffic via the cell during instance(s) of the non-active time period. Likewise, during a cell discontinuous reception (DRX) cycle, there is an active time period during which the network entity can receive uplink traffic via the cell, and there is a non-active time period during which the network entity refrains from receiving certain uplink traffic via the cell. In response to a cell DRX cycle being activated, the UE may also refrain sending certain uplink traffic via the cell during instances of the non-active time period. Accordingly, for cell DTX/DRX cycles, the respective terms transmission and reception derive their meaning from the perspective of the network entity (e.g., a base station, TRP, any disaggregated entity thereof, or the like). As used herein, cell DTX/DRX cycle may refer to a cell DTX cycle, a cell DRX cycle, and/or both.

Technical problems for cell DTX/DRX cycles may include, for example, effective handling of interactions between cell discontinuous communications (e.g., cell DTX and/or DRX) and measurement occasions, which may interrupt certain communications. For certain wireless communications systems (e.g., 5G NR systems), the expected UE behavior may not be established when the UE encounters an active time period, of a cell DTX and/or DRX cycle, that overlaps in time with a measurement occasion including an interruption time (such as a measurement gap and/or interruption length as discussed herein). For example, when the active time period of a cell DTX cycle overlaps in time with a measurement occasion, it may not be established whether any communications in the active time period can be interrupted by the measurement occasion. As another example, it may not be established whether a UE can skip a measurement occasion to receive transmission(s) during the active time period of the cell DTX cycle.

Aspects described herein may overcome the aforementioned technical problem(s), for example, by providing schemes for interaction between cell discontinuous communications and measurement occasions. In certain aspects, a UE may obtain an indication of one or more rules for radio measurement, such as reference signal measurement. The rules(s) may indicate whether to prioritize communications during an active time period of a cell DTX and/or DRX cycle over a measurement occasion, or vice versa. In certain aspects, the rule(s) may indicate whether to prioritize communications during an active time period of a cell DTX and/or DRX cycle over a measurement occasion based on the measurement occasion partially overlapping in time with the active time period. In certain aspects, the rule(s) may indicate whether to adjust the duration of the active time period of a cell DTX and/or DRX cycle based on the measurement occasion partially overlapping in time with the active time period. The rule(s) may be communicated via signaling and/or pre-configured.

Certain techniques for interaction between cell discontinuous communications and measurement occasions described herein may provide various beneficial technical effects and/or advantages. The techniques for interaction between cell discontinuous communications and measurement occasions may enable improved wireless communications performance, such as reduced latencies and/or reduced power consumption. The improved wireless communications performance may be attributable to the rule(s) allowing for dynamic prioritization of cell DTX and/or DRX communications or radio measurements. As an example, prioritization of cell DTX and/or DRX communications may enable certain communications (such as extended reality traffic or other low latency traffic) to maintain certain performance specifications (such as latencies) and/or levels of power consumption (at the network entity and/or UE) without interruptions from radio measurements. In certain cases, prioritization of radio measurements may enable a network entity to be responsive to changes in channel conditions over time, for example, due to UE mobility. For example, prioritization of radio measurements may allow the network entity to perform mobility management procedures (such as a handover, cell switch, and/or beam switch) before a beam failure and/or radio link failure.

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

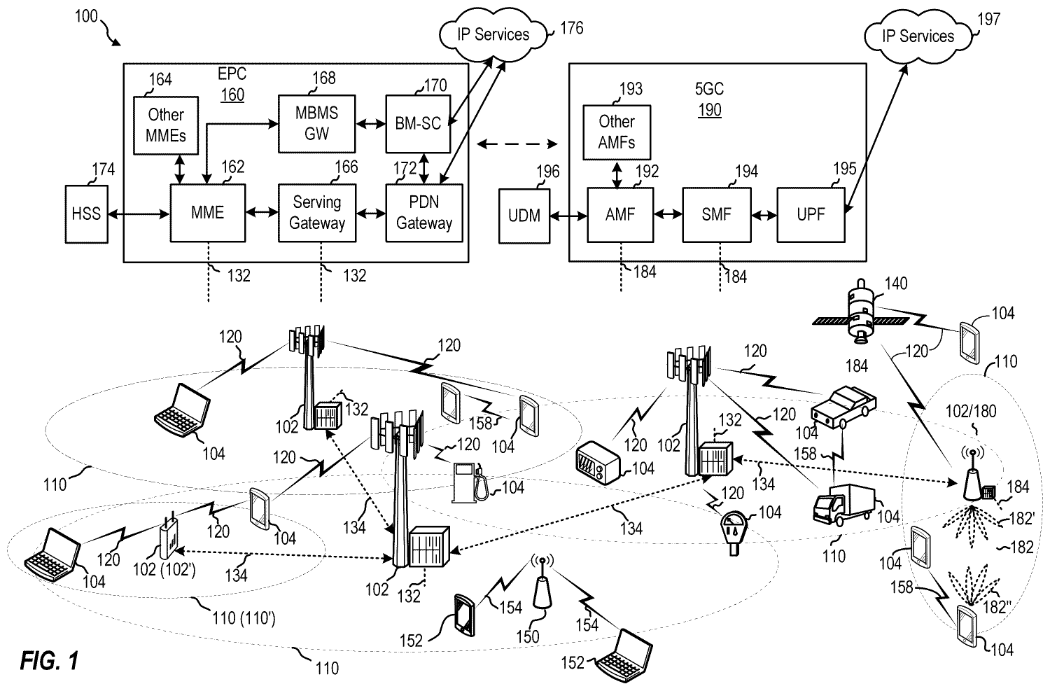

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 includes terrestrial aspects, such as ground-based network entities (e.g., BSs 102), and non-terrestrial aspects (also referred to herein as non-terrestrial network entities), such as satellite 140 and/or aerial or spaceborne platform(s), which may include network entities on-board (e.g., one or more BSs) capable of communicating with other network elements (e.g., terrestrial BSs) and UEs.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, data centers, or other similar devices. UEs 104 may also be referred to more generally as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

Generally, a cell may refer to a portion, partition, or segment of wireless communication coverage served by a network entity within a wireless communication network. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

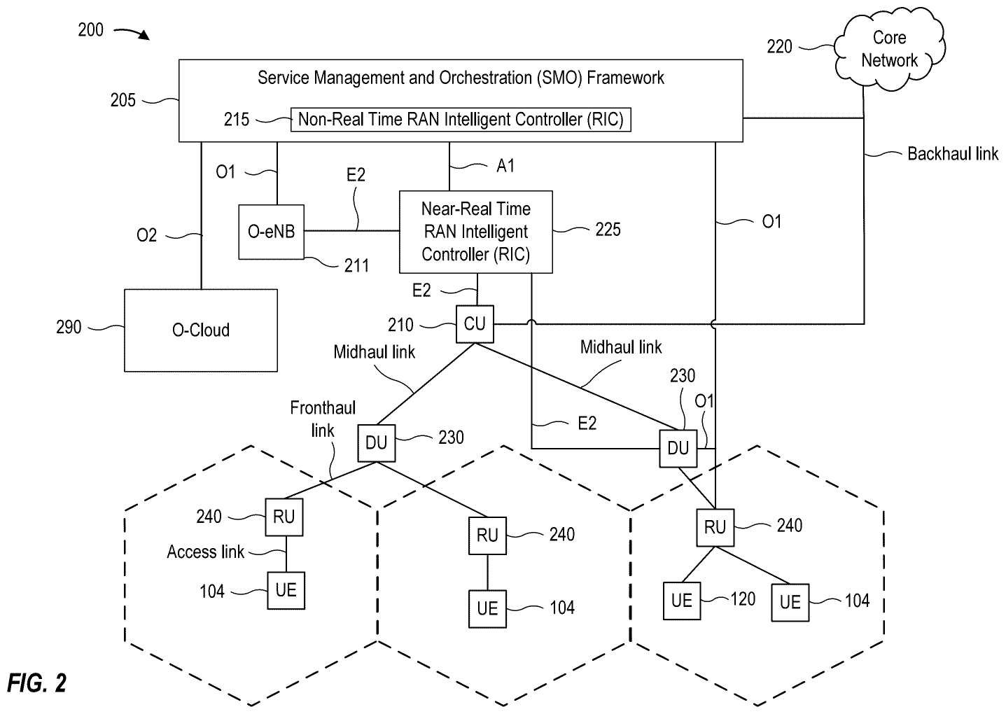

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHZ-7125 MHz, which is often referred to (interchangeably) as “Sub-6 GHz”. Similarly, 3GPP currently defines Frequency Range 2 (FR2) as including 24,250 MHZ-71,000 MHZ, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mm Wave/near mm Wave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QOS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUS 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via 01) or via creation of RAN management policies (such as A1 policies).

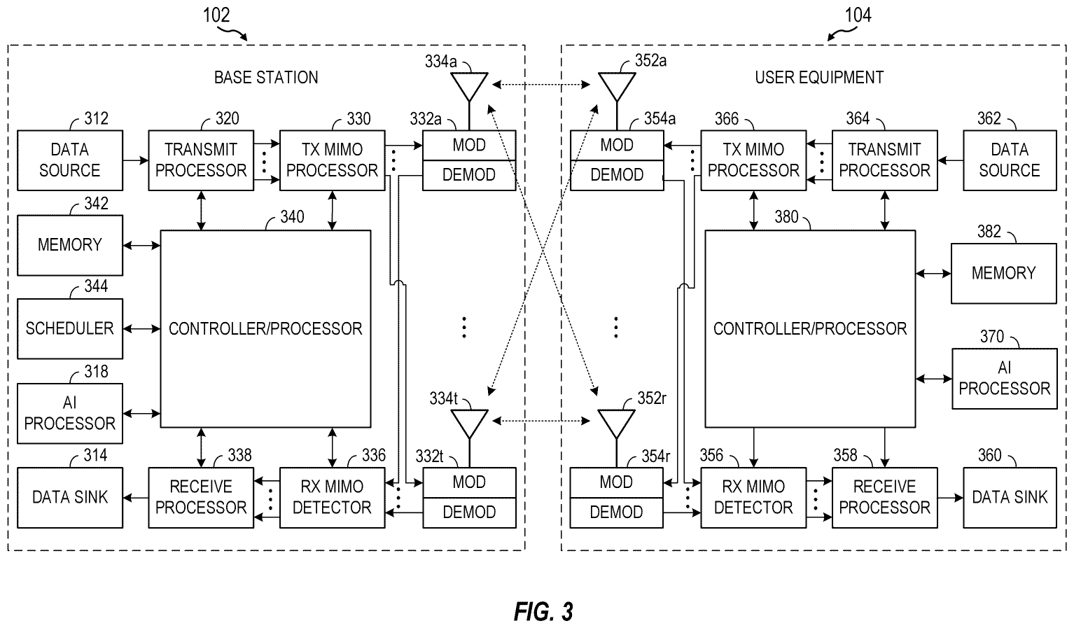

FIG. 3 depicts aspects of an example BS 102 and a UE 104.

Generally, BS 102 includes various processors (e.g., 318, 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 314). For example, BS 102 may send and receive data between BS 102 and UE 104. BS 102 includes controller/processor 340, which may be configured to implement various functions described herein related to wireless communications. Note that the BS 102 may have a disaggregated architecture as described herein with respect to FIG. 2.

Generally, UE 104 includes various processors (e.g., 358, 364, 366, 370, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

RX MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a RX MIMO detector 336 if applicable, and further processed by a receive processor 338 to obtain decoded data and control information sent by UE 104. Receive processor 338 may provide the decoded data to a data sink 314 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

In various aspects, artificial intelligence (AI) processors 318 and 370 may perform AI processing for BS 102 and/or UE 104, respectively. The AI processor 318 may include AI accelerator hardware or circuitry such as one or more neural processing units (NPUs), one or more neural network processors, one or more tensor processors, one or more deep learning processors, etc. The AI processor 370 may likewise include AI accelerator hardware or circuitry. As an example, the AI processor 370 may perform AI-based beam management, AI-based channel state feedback (CSF), AI-based antenna tuning, and/or AI-based positioning (e.g., non-line of sight positioning prediction). In some cases, the AI processor 318 may process feedback from the UE 104 (e.g., CSF) using hardware accelerated AI inferences and/or AI training. The AI processor 318 may decode compressed CSF from the UE 104, for example, using a hardware accelerated AI inference associated with the CSF. In certain cases, the AI processor 318 may perform certain RAN-based functions including, for example, network planning, network performance management, energy-efficient network operations, etc.

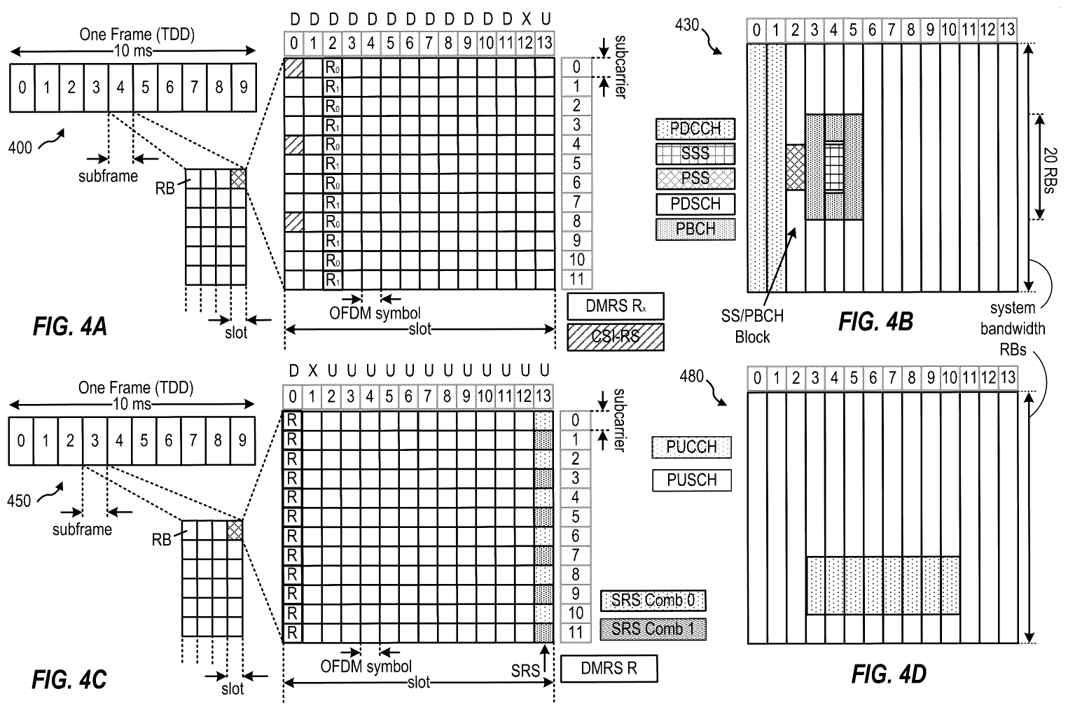

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for both DL and UL. Wireless communications frame structures may also be time division duplex (TDD), in which, for a particular set of subcarriers, subframes within the set of subcarriers are dedicated for either DL or UL.

In FIGS. 4A and 4C, the wireless communications frame structure is TDD where Dis DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology, which may define a frequency domain subcarrier spacing and symbol duration as further described herein. In certain aspects, given a numerology μ, there are 2^{μ} slots per subframe. Thus, numerologies (μ) 0 to 6 may allow for 1, 2, 4, 8, 16, 32, and 64 slots, respectively, per subframe. In some cases, the extended CP (e.g., 12 symbols per slot) may be used with a specific numerology, e.g., numerology 2 allowing for 4 slots per subframe. The subcarrier spacing and symbol length/duration are a function of the numerology. The subcarrier spacing may be equal to 2^{μ}×15 kHz, where u is the numerology 0 to 6. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB), and in some cases, referred to as a synchronization signal block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

Aspects Related to Cell Discontinuous Communications with Measurement Occasions

Aspects of the present disclosure provide schemes for interaction between cell discontinuous communications (such as cell DTX/DRX communications) and measurement occasions. The schemes described herein may enable various beneficial technical effects, such as reduced latencies and/or reduced power consumption.

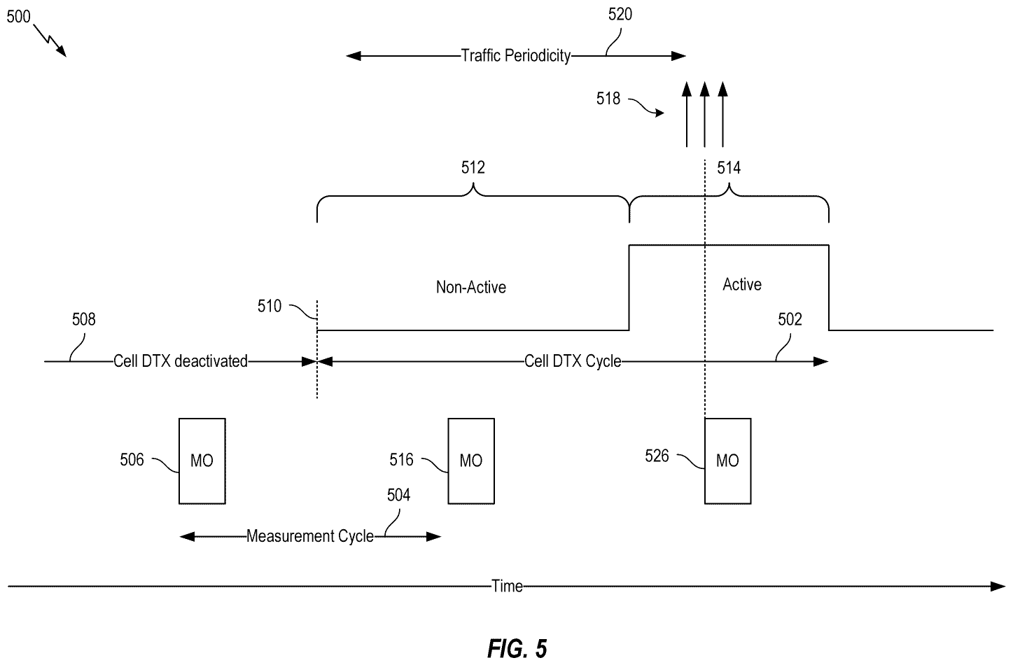

FIG. 5 depicts an example arrangement 500 of a cell DTX cycle 502 and a measurement cycle 504 over time. In this example, a UE may be configured (e.g., via a pre-configuration and/or signaling) to communicate with a network entity (e.g., a base station or any disaggregated entity thereof) according to the cell DTX cycle 502 and the measurement cycle 504. One or more measurement occasions (MOs) 506 may be arranged across the measurement cycle 504, which may occur periodically. The UE may be configured (e.g., via a pre-configuration and/or signaling) to obtain radio measurement(s) during the measurement occasion(s) 506, 516, 526 of periodic instances of the measurement cycle. The radio measurements may include channel measurements, reference signal measurements, and/or interference measurements. A measurement occasion 506 may have one or more interruption times during which the UE may not be expected to communicate certain traffic or signaling while obtaining radio measurement(s) associated with the measurement occasion 506. The interruption time(s) may provide the UE with enough time to switch from a transmit mode to receive mode and/or vice versa. In certain cases, the interruption time(s) may be the entire duration of the measurement occasion (such as a measurement gap) and/or a portion of the measurement occasion (such as the interruption length(s) of a measurement gap). In certain cases, the UE may obtain radio measurement(s) during the measurement occasion 506 of the measurement cycle 504, for example, while the cell DTX cycle 502 is deactivated in a corresponding deactivated time period 508.

At a specific occasion 510 (e.g., a particular symbol or slot), the cell DTX cycle 502 may be activated, for example, as indicated by a cell DTX configuration and/or an activation indication. As an example, the network entity may send, to the UE, an indication that the cell DTX cycle 502 is activated starting at the specific occasion 510. The network entity may inform the UE(s) that the cell DTX cycle 502 is activated and/or deactivated via control signaling, such as radio resource control (RRC) signaling, medium access control (MAC) signaling, downlink control information (DCI) (e.g., a group-common DCI), etc. The network entity may configure the UE with one or more parameters associated with the cell DTX cycle. The parameter(s) may include, for example, a periodicity of the cell DTX cycle 502, a duration of a non-active time period 512, and/or a duration of an active time period 514.

The cell DTX cycle 502 may be associated with one or more cells of the network entity. The cell DTX cycle 502 may have a periodic sequence of time periods including a non-active time period 512 followed by an active time period 514 (or vice versa). Note that multiple non-active time periods and/or active time periods may be arranged in the cell DTX cycle 502. In the non-active time period 512, the network entity may refrain from sending certain downlink traffic and/or signaling via the cell(s) associated with the cell DTX cycle 502. The downlink traffic and/or signaling may include, for example, semi-persistent scheduling (SPS) transmissions, DCI via a UE-specific search space set (USS), periodic or semi-persistent reference signal(s) (e.g., CSI-RS), certain DCI formats (e.g., PDCCH with DCI format 2_X, where X=0, 1, . . . , 5), and/or the like. During the non-active time period 512, communication with the network entity via the cell(s) may be unavailable, limited, or reduced relative to the active time period 514. In the active time period 514, the network entity may send any traffic or signaling via the cell(s), and in particular, the traffic or signaling dropped (e.g., not communicated) in the non-active time period 512. During the active time period 514, communication with the network entity via the cell(s) may be allowed. Thus, the cell DTX cycle 502 may enable the network entity and/or UE to reduce power consumption, for example, by entering a lower power state during the non-active time period(s).

In certain cases, the UE may be configured to obtain radio measurement(s) during a measurement occasion 516 that occurs in an instance of the non-active time period 512 of the cell DTX cycle 502. As further described herein, the UE may be configured (e.g., via pre-configuration and/or signaling) with one or more rules that indicate the UE is permitted to obtain radio measurement(s) during measurement occasion(s) 506 that occur in the non-active time period 512 of the cell DTX cycle 502. As the cell DTX cycle may not affect the signaling (e.g., reference signals communicated via neighbor or candidate cell(s) or the cell(s) associated with the cell DTX cycle 502) for radio measurements, the UE may obtain radio measurement(s) during the measurement occasion 506. As certain transmissions via the cell(s) associated with the cell DTX cycle 502 are not expected during the non-active time period 512, the interruption time(s) associated with the measurement occasion 506 may also not affect such communications between the UE and the network entity.

In certain cases, the UE may be configured to obtain radio measurement(s) during a measurement occasion 526 that occurs in an instance of the active time period of the cell DTX cycle. For example, the measurement occasion 526 may completely overlap in time with the active time period 514. As further described herein, the UE may be configured (e.g., via pre-configuration and/or signaling) with one or more rules that indicate whether to perform the radio measurements in the measurement occasion 526 or obtain any transmissions from the network entity during the active time period 514.

As an example, the UE may communicate certain traffic 518 with the network entity (such as extended reality (XR) traffic, cloud-gaming traffic, and/or the like) during the active time period 514. As used herein, XR may include virtual reality (VR), augmented reality (AR), and/or mixed reality (MR). XR traffic may have certain performance specifications including, for example, a packet delay budget (PDB) of 10 ms and/or packet success rate of 90 to 99%. In certain cases, the performance specifications used for XR traffic may be an example of the performance specifications used for other types of traffic, such as cloud gaming. The PDB may be an upper bound for the time that a packet may be delayed between a UE and the network entity. The packet success rate may be a lower bound for the rate of packets that have been obtained and successfully processed at the UE. XR traffic may include a downlink stream that carries video, audio, and/or data; and the XR traffic may include an uplink stream that carries pose and/or control information associated with the movements or actions of the user. The downlink stream may be communicated with a periodicity of 16.66 ms (e.g., the traffic periodicity 520), for example, for a frame generation rate of 60 frames per second (fps), and the uplink stream may be communicated with a periodicity of 4 ms. In addition, measurement occasions 506, 516, 526 (e.g., measurement gaps) may be configured with a specific periodicity (e.g., 20, 40, 80, or 160 ms).

Due to the conflicting periodicities between the XR traffic and measurement occasions, all of the measurement occasions may not be arranged between certain XR traffic bursts (or arranged during the non-active time period 512), and thus, some measurement occasions (e.g., the measurement occasion 526) may overlap in time with the XR traffic (e.g., the traffic 518) and/or the active time period 514. Accordingly, the rules(s) described herein may allow dynamic prioritization of communications (e.g., the traffic 518) during the active time period 514 and/or the measurement occasion(s), for example, depending on the performance specifications of the communications, channel conditions, channel usage, load balancing at the network entity, power consumption, UE mobility, or the like.

Note that the cell DTX cycle 502 may be an example of cell discontinuous communications. Aspects of the present disclosure may be applied to a cell DRX cycle. As an example, the non-active time period 512 and the active time period 514 depicted in FIG. 5 may be an example of the respective time periods of a cell DRX cycle. In the non-active time period of the cell DRX cycle, the network entity may refrain from receiving or monitoring for certain uplink traffic and/or signaling including, for example, configured grant (CG) transmission(s), a scheduling request (SR), periodic or semi-persistent sounding reference signal(s), periodic or semi-persistent CSI report(s), etc. In the active time period of the cell DRX cycle, the network entity may receive or monitor for any uplink traffic and/or signaling, and in particular, the traffic or signaling dropped (e.g., not communicated) in the non-active time period. Accordingly, the rule(s) described herein may be applied to a cell DTX cycle and/or cell DRX cycle.

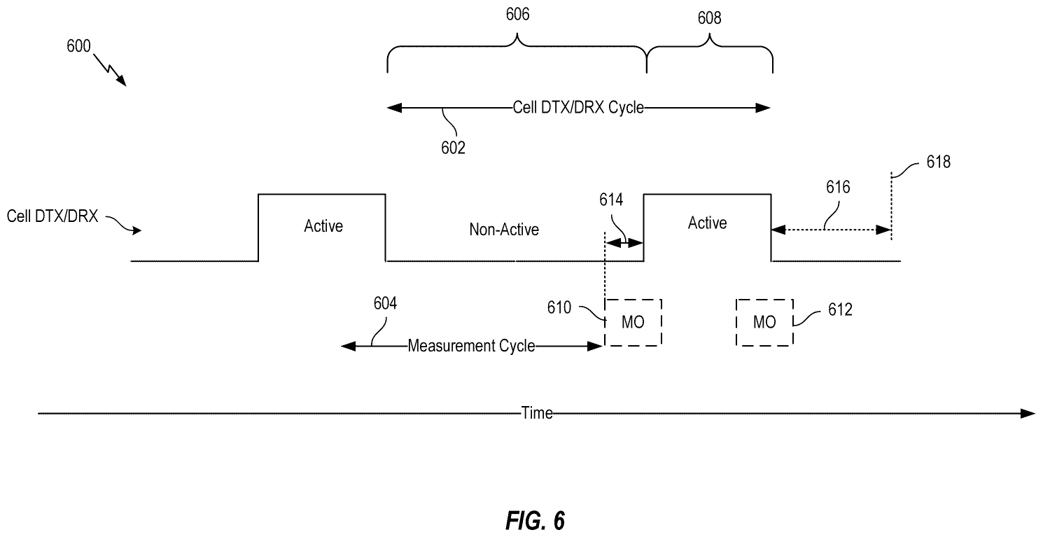

FIG. 6 depicts example scheme(s) 600 for interactions between measurement occasions and cell discontinuous communications, such as a cell DTX cycle and/or cell DRX cycle, for example, with respect to FIG. 5. In this example, a UE may be configured (e.g., via a pre-configuration and/or signaling) to communicate with a network entity according to a cell DTX/DRX cycle 602 and a measurement cycle 604, for example, as described herein with respect to FIG. 5. The cell DTX/DRX cycle 602 may be associated with one or more cells used for communications between the network entity and the UE. The cell DTX/DRX cycle 602 may have a non-active time period 606 and an active time period 608, for example, as described herein with respect to FIG. 5.

In certain aspects, the network entity may be aware of the periodicity of the cell DTX/DRX cycle 602 and the periodicity of the measurement cycle 604. To resolve instances when a measurement occasion (completely or partially) overlaps in time with the active time period 608, the UE may obtain, from the network entity, one or more rules that indicate to prioritize communication via the cell during the active time period 608 over the measurement occasion (such as the measurement occasion 610, 612). Based on the rule(s), the UE may communicate with the network entity via the cell while refraining from obtaining radio measurement(s) during the measurement occasion 610, 612 that overlaps in time with the active time period 608. The prioritization of communication via the cell during the active time period 608 may enable the network entity and the UE to satisfy certain performance specifications (such as PDB, packet success rate, and/or the like) associated with traffic and/or signaling communicated during the active time period 608. As used herein, a prioritization associated with the active time period may refer to a prioritization that applies to communication via a cell that is allowed during the active time period.

In certain aspects, the rule(s) may indicate to prioritize communication via the cell(s) during the active time period 608 over radio measurement(s) when a measurement occasion (e.g., the measurement occasion 610) partially overlaps in time with the respective active time period 608 of the cell DTX/DRX cycle 602. In certain cases, the prioritization associated with the active time period 608 may apply when an interruption time of the measurement occasion 610 occurs within a certain time window 614 from the active time period 608. As an example, when the beginning of an interruption time of the measurement occasion 610 starts within a certain time window 614 from the beginning of the active time period 608, the UE may prioritize communication (such as PDCCH, PDSCH, PUSCH, and/or PUCCH communications) via the cell during the active time period 608 over radio measurement(s) in the measurement occasion 610.

In certain cases, the UE may obtain, from the network entity, one or more rules that indicate to prioritize radio measurement (e.g., reference signal measurement, channel measurement, and/or interference measurement) over communication via the cell associated with the cell DTX/DRX cycle 602 during the active time period 608. In certain cases, the prioritization may be applicable to any measurement occasion that overlaps in time with instances of the active time period, for example, with respect to the periodicity of the cell DTX/DRX cycle. Based on the rule(s), the UE may obtain radio measurement(s) in the measurement occasion 610, 612 that overlaps in time with the active time period 608. As an example, the UE may obtain reference signal(s) in the measurement occasion 610 that overlaps in time with the active time period 608 regardless of whether the measurement occasion interferes with or interrupts communications via the cell(s) during the active time period 608. The prioritization of radio measurement during the active time period 608 may enable the network entity and/or UE to adapt to changes in channel conditions and/or UE mobility over time.

In certain aspects, the rule(s) may indicate that the prioritization (associated with the active time period or the measurement occasion) applies semi-statically, for example, until a deactivation indication is communicated to the UE. As an example, the prioritization associated the active time period may be applicable to any instances of the active time period 608 with respect to the periodicity of the cell DTX/DRX cycle where measurement occasion(s) 610, 612 overlap in time with the respective active time period 608.

In certain aspects, the rule(s) may indicate specific instance(s) of the active time period and/or measurement occasions to which the prioritization applies. For example, the rule(s) may indicate that communication via the cell(s) in a specific instance of the active time period 608 is prioritized over radio measurement(s).

In certain aspects, the rule(s) may indicate a time period during which the prioritization (associated with the active time period or the measurement occasion) is active. As an example, the prioritization associated with the active time period may be active for a specific time period (such as 60 seconds, 5 minutes, or the like).

In certain aspects, the rule(s) may indicate to adjust the duration of the active time period 608 when a measurement occasion (such as the measurement occasion 612) partially overlaps in time with the active time period 608. In certain cases, the rule(s) may indicate to extend the active time period 608 (e.g., by an extension time 616) to fully overlap in time with the measurement occasion 612 when the active time period 608 partially overlaps in time with the measurement occasion 612. Such an extension may be treated as applying the prioritization associated with the active time period 608 as discussed herein.

In certain cases, the rule(s) may indicate to pause or hold a timer that defines the duration of the active time period 608 and/or the end time 618 of the active time period 608 when the measurement occasion 612 partially overlaps in time with the active time period 608. For example, at the beginning of the active time period 608, the UE may start the timer, and the timer may be paused for the extension time 616 such that the active time period 608 fully overlaps in time with the measurement occasion 612. Such a pause or hold on the timer may be treated as applying the prioritization associated with the active time period as discussed herein.

In certain cases, the rule(s) may indicate to reduce the active time period and/or end the timer early in order to apply a prioritization for the radio measurement(s).

In certain aspects, the rule(s) may indicate to perform radio measurement(s) associated with candidate or neighbor cell(s) during a measurement occasion that overlaps in time with the non-active time period of the cell DTX/DRX cycle (for example, with respect to the measurement occasion 516 as depicted in FIG. 5). A candidate or neighbor cell may be a possible target for a handover, cell switch, or beam switch from a source cell (e.g., the current serving cell); and in certain cases, the candidate or neighbor cell may have a coverage area adjacent to or overlapping with the coverage area of the source cell. Such an indication may effectively be treated as a prioritization associated with the active time period as described herein.

In certain aspects, the UE may apply the rule(s) described herein after a time period from communication of an activation indication for the cell DTX/DRX cycle. As an example, the UE may obtain, from the network entity, signaling that indicates to activate the cell DTX/DRX cycle. The signaling may be or include RRC signaling, MAC signaling, DCI, or the like. In certain cases, the activation indication may be communicated via DCI format 2_9. In response to the activation indication for the cell DTX/DRX cycle, the UE may apply the rule(s) described herein after a certain time period from communication of the activation indication.

Example Signaling Related to Cell Discontinuous Communications with Measurement Occasions

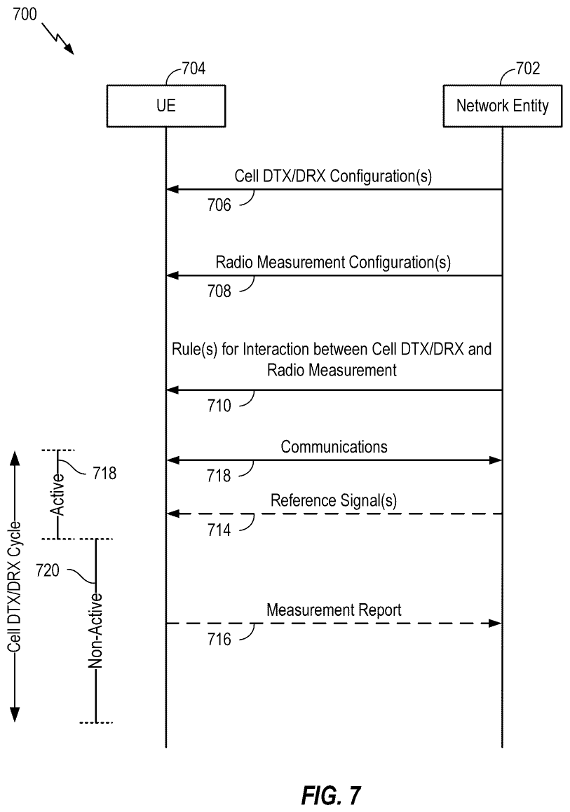

FIG. 7 depicts a process flow 700 for signaling related to cell discontinuous communications with measurement occasion(s) in a system between a network entity 702 and a user equipment (UE) 704. In some aspects, the network entity 702 may be an example of the BS 102 depicted and described with respect to FIGS. 1 and 3 or a disaggregated base station depicted and described with respect to FIG. 2. Similarly, the UE 704 may be an example of UE 104 depicted and described with respect to FIGS. 1 and 3. However, in other aspects, UE 704 may be another type of wireless communications device and network entity 702 may be another type of network entity or network node, such as those described herein. Note that any operations or signaling illustrated with dashed lines may indicate that that operation or signaling is an optional or alternative example.

At 706, the UE 704 obtains, from the network entity 702, a first configuration for cell discontinuous communications (e.g., cell DTX/DRX configuration(s)). The first configuration may indicate an active time period 718 and a non-active time period 720 associated with a cell DTX/DRX cycle, for example, as described herein with respect to FIGS. 5 and 6. The first configuration may be communicated via RRC signaling, MAC signaling, DCI, system information, and/or the like.

At 708, the UE 704 obtains, from the network entity 702, a second configuration for radio measurement. In certain aspects, the second configuration may indicate one or more measurement occasions for radio measurement (e.g., reference signal measurement), for example, as described herein with respect to FIGS. 5 and 6. The second configuration may be communicated via RRC signaling, MAC signaling, DCI, system information, and/or the like. In certain cases, the second configuration may be communicated via the same or different signaling used to communicate the first configuration.

At 710, the UE 704 obtains, from the network entity 702, one or more rules for radio measurement (e.g., reference signal measurement). The rule(s) may indicate the expected UE behavior for interactions between the cell DTX/DRX cycle and the measurement occasion(s), for example, as described herein with respect to FIG. 6. In certain cases, the rule(s) may indicate a prioritization associated with the active time period 718 or the measurement occasion, for example, depending on the performance specifications of the communications, channel conditions, channel usage, load balancing, power consumption, UE mobility, or the like. The rule(s) may be communicated via RRC signaling, MAC signaling, DCI, system information, and/or the like. In certain cases, the rule(s) may be communicated via the same or different signaling used to communicate the first configuration and/or the second configuration.

At 712, the UE 704 communicates with the network entity 702 based on the first configuration, the second configuration, and the rule(s) during the active time period 718. In certain cases, the UE 704 may obtain downlink signaling and/or send downlink signaling (e.g., XR traffic) when the rule(s) indicate to prioritize communication via the cell during the active time period 718, and the UE 704 may refrain from obtaining radio measurement(s) during the active time period 718.

At 714, the UE 704 optionally obtains, from the network entity 702, reference signal(s) in a measurement occasion that overlaps in time with the active time period 718. For example, the UE 704 may obtain the reference signal(s) in the measurement occasion when the rule(s) indicate to prioritize radio measurement during the active time period 718. The UE 704 may allow obtaining radio measurement(s) to interrupt communications via the cell(s) during the active time period 718. The reference signal(s) may include an SSB, CSI-RS, DMRS, and/or any other suitable reference signal. The reference signal(s) may be associated with a serving cell, a candidate cell, and/or a neighbor cell (or one or more beams associated with such cell(s)). The UE 704 may determine radio measurement(s) associated with the reference signal(s). The radio measurement(s) may include, for example, a channel quality indicator (CQI), a signal-to-noise ratio (SNR), a signal-to-interference plus noise ratio (SINR), a signal-to-noise-plus-distortion ratio (SNDR), a received signal strength indicator (RSSI), a reference signal received power (RSRP), a reference signal received quality (RSRQ), and/or a block error rate (BLER).

At 716, the UE 704 optionally sends, to the network entity 702, a measurement report associated with the radio measurement(s) obtained at 714. The measurement report may indicate the radio measurement(s) associated with the serving cell and/or candidate or neighbor cell(s). Based on the measurement report (e.g., indicating a stronger signal strength associated with radio measurements for a neighbor cell), the network entity 702 may determine to perform a handover, cell switch, and/or beam switch for communications with the UE 704. A prioritization associated with a measurement occasion may enable the network entity 702 and/or UE 704 to adapt to changes in channel conditions and/or UE mobility over time. Accordingly, the prioritization associated with a measurement occasion may enable reduced latencies, interruption times, packet losses, handover failures, and/or ping-ponging between cells, beams, and/or network entities.

Note that the process flow illustrated in FIG. 7 is an example of certain prioritization rule(s) during the active time period of the cell DTX/DRX cycle, and aspects of the present disclosure may be applied to any of the rule(s) described herein with respect to FIG. 6. Note that the process flow illustrated in FIG. 7 is described herein to facilitate an understanding of certain rule(s) for interactions between cell discontinuous communications and measurement occasions as described herein with respect to FIG. 6, and aspects of the present disclosure may be performed in various manners via alternative or additional signaling and/or operations. In certain aspects, the operations and/or signaling of FIG. 7 may occur in an order different from that described or depicted, and various actions, operations, and/or signaling may be added, omitted, or combined.

Example Operations of Cell Discontinuous Communications with Measurement Occasions

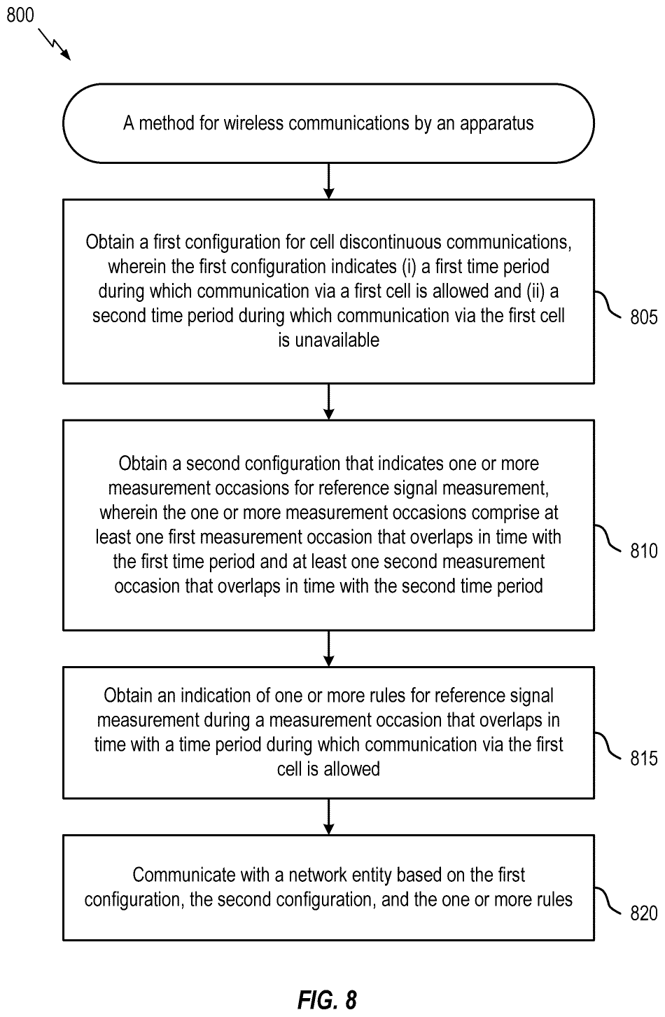

FIG. 8 shows a method 800 for wireless communications by an apparatus, such as UE 104 of FIGS. 1 and 3.

Method 800 begins at block 805 with obtaining a first configuration for cell discontinuous communications, wherein the first configuration indicates (i) a first time period during which communication via a first cell is allowed and (ii) a second time period during which communication via the first cell is unavailable, for example, as described herein with respect to FIGS. 5-7.

Method 800 then proceeds to block 810 with obtaining a second configuration that indicates one or more measurement occasions for reference signal measurement, wherein the one or more measurement occasions comprise at least one first measurement occasion that overlaps in time with the first time period and at least one second measurement occasion that overlaps in time with the second time period, for example, as described herein with respect to FIGS. 5-7.

Method 800 then proceeds to block 815 with obtaining an indication of one or more rules for reference signal measurement during a measurement occasion that overlaps in time with a time period during which communication via the first cell is allowed, for example, as described herein with respect to FIGS. 6 and 7.

Method 800 then proceeds to block 820 with communicating with a network entity based on the first configuration, the second configuration, and the one or more rules, for example, as described herein with respect to FIGS. 6 and 7.

In certain aspects, the one or more rules indicate to prioritize communication via the first cell over reference signal measurement; and block 820 includes refraining from monitoring for one or more first reference signals in the at least one first measurement occasion, monitoring for one or more second reference signals in the at least one second measurement occasion, and communicating signaling with the network entity during the first time period.

In certain aspects, the one or more rules further indicate a third time period during which communication via the first cell is prioritized over reference signal measurement.

In certain aspects, the one or more rules indicate to prioritize reference signal measurement over communication via the first cell; and block 820 includes obtaining one or more reference signals in the at least one first measurement occasion.

In certain aspects, the one or more rules indicate a third time period during which reference signal measurement is prioritized over communication via the first cell.

In certain aspects, the one or more rules indicate to prioritize communication via the first cell over reference signal measurement during the measurement occasion that overlaps with the time period during which communication via the first cell is allowed when an interruption time of the measurement occasion occurs within a time window from the time period; and block 820 includes refraining from monitoring for one or more reference signals in the at least one first measurement occasion based on occurrence of a first interruption time of the at least one first measurement occasion within the time window from the first time period.

In certain aspects, the one or more rules indicate to extend the time period to fully overlap in time with the measurement occasion when the time period partially overlaps in time with the measurement occasion; and block 820 includes extending the first time period to fully overlap in time with the at least one first measurement occasion based on partial overlap in time of the first time period with the at least one first measurement occasion, and refraining from monitoring for one or more reference signals in the at least one first measurement occasion during the first time period.

In certain aspects, the one or more rules indicate to pause a timer that defines an end time of the time period when the measurement occasion partially overlaps in time with the time period; and block 820 includes pausing the timer based on partial overlap in time of the at least one first measurement occasion with the first time period such that the first time period fully overlaps in time with the at least one first measurement occasion, and refraining from monitoring for one or more reference signals in the at least one first measurement occasion during the first time period.

In certain aspects, the one or more rules indicate to perform reference signal measurement for a neighbor cell during at least one measurement occasion that overlaps in time with at least one time period during which communication via the first cell is unavailable; and block 820 includes refraining from monitoring for one or more first reference signals in the at least one first measurement occasion during the first time period, and obtaining one or more second reference signals via a second cell in the at least one second measurement occasion during the second time period.

In certain aspects, method 800 further includes obtaining an indication to activate the first configuration; and block 820 includes communicating with the network entity based on the one or more rules after a third time period from communication of the indication to activate the first configuration.

In certain aspects, the first configuration indicates that the first time period and the second time period are part of a periodic cycle associated with cell discontinuous communications; and the second configuration indicates that the one or more measurement occasions occur according to a periodicity.

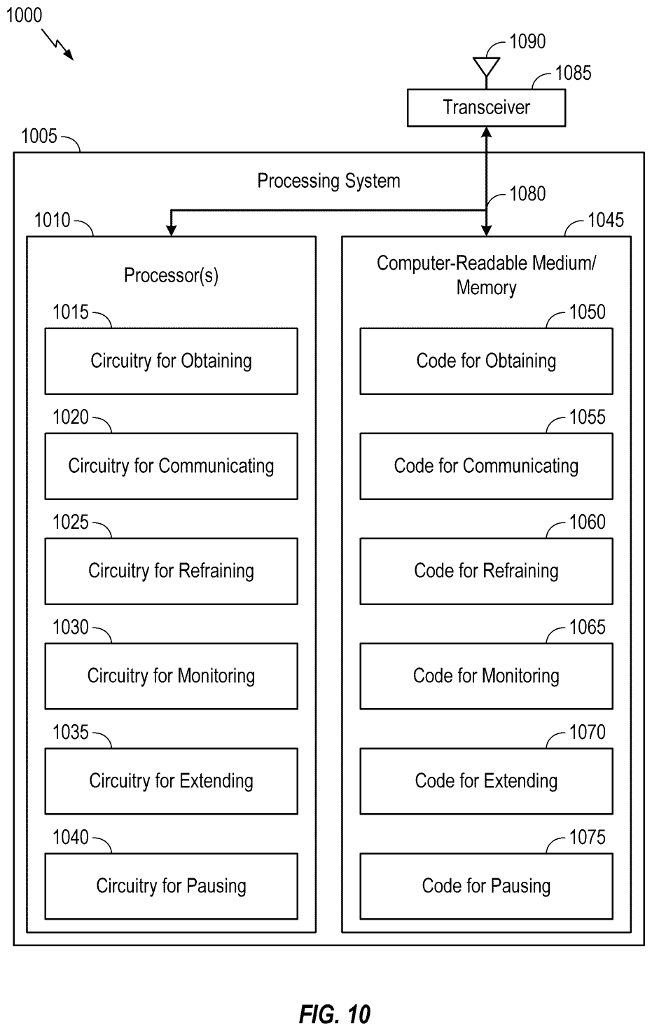

In certain aspects, method 800, or any aspect related to it, may be performed by an apparatus, such as communications device 1000 of FIG. 10, which includes various components operable, configured, or adapted to perform the method 800. Communications device 1000 is described below in further detail.

Note that FIG. 8 is just one example of a method, and other methods including fewer, additional, or alternative operations are possible consistent with this disclosure.

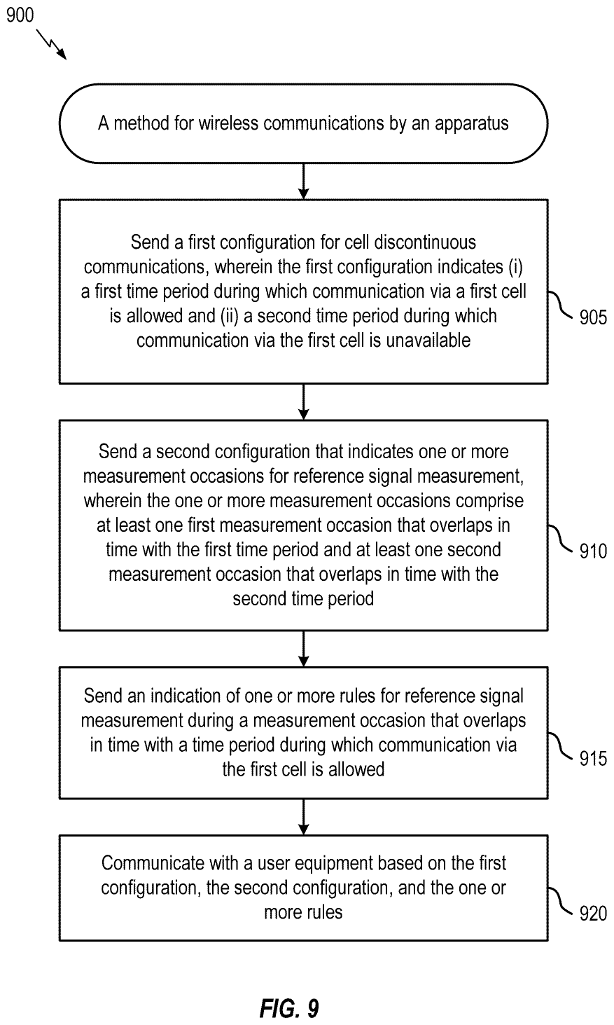

FIG. 9 shows a method 900 for wireless communications by an apparatus, such as BS 102 of FIGS. 1 and 3, or a disaggregated base station as discussed with respect to FIG. 2.

Method 900 begins at block 905 with sending a first configuration for cell discontinuous communications, wherein the first configuration indicates (i) a first time period during which communication via a first cell is allowed and (ii) a second time period during which communication via the first cell is unavailable, for example, as described herein with respect to FIGS. 5-7.

Method 900 then proceeds to block 910 with sending a second configuration that indicates one or more measurement occasions for reference signal measurement, wherein the one or more measurement occasions comprise at least one first measurement occasion that overlaps in time with the first time period and at least one second measurement occasion that overlaps in time with the second time period, for example, as described herein with respect to FIGS. 5-7.

Method 900 then proceeds to block 915 with sending an indication of one or more rules for reference signal measurement during a measurement occasion that overlaps in time with a time period during which communication via the first cell is allowed, for example, as described herein with respect to FIGS. 6 and 7.

Method 900 then proceeds to block 920 with communicating with a user equipment based on the first configuration, the second configuration, and the one or more rules, for example, as described herein with respect to FIGS. 6 and 7.

In certain aspects, the one or more rules indicate to prioritize communication via the first cell over reference signal measurement; and block 920 includes communicating signaling with the user equipment during the first time period.

In certain aspects, the one or more rules further indicate a third time period during which communication via the first cell is prioritized over reference signal measurement.

In certain aspects, the one or more rules indicate to prioritize reference signal measurement over communication via the first cell; and block 920 includes sending one or more reference signals in the at least one first measurement occasion.

In certain aspects, the one or more rules indicate a third time period during which reference signal measurement is prioritized over communication via the first cell.

In certain aspects, the one or more rules indicate to prioritize communication via the first cell over reference signal measurement during the measurement occasion that overlaps with the time period during which communication via the first cell is allowed when an interruption time of the measurement occasion occurs within a time window from the time period.

In certain aspects, the one or more rules indicate to extend the time period to fully overlap in time with the measurement occasion when the time period partially overlaps in time with the measurement occasion.

In certain aspects, the one or more rules indicate to pause a timer that defines an end time of the time period when the measurement occasion partially overlaps in time with the time period.

In certain aspects, the one or more rules indicate to perform reference signal measurement for a neighbor cell during at least one measurement occasion that overlaps in time with at least one time period during which communication via the first cell is unavailable; and block 920 includes sending one or more second reference signals via a second cell in the at least one second measurement occasion during the second time period.

In certain aspects, method 900 further includes obtaining an indication to activate the first configuration; and block 920 includes communicating with the user equipment based on the one or more rules after a third time period from communication of the indication to activate the first configuration.

In certain aspects, the first configuration indicates that the first time period and the second time period are part of a periodic cycle associated with cell discontinuous communications; and the second configuration indicates that the one or more measurement occasions occur according to a periodicity.

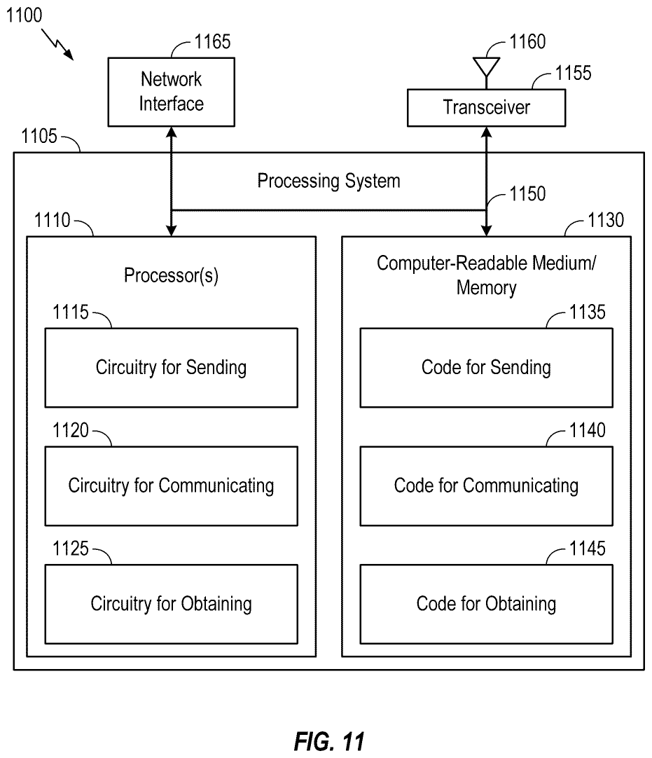

In certain aspects, method 900, or any aspect related to it, may be performed by an apparatus, such as communications device 1100 of FIG. 11, which includes various components operable, configured, or adapted to perform the method 900. Communications device 1100 is described below in further detail.

Note that FIG. 9 is just one example of a method, and other methods including fewer, additional, or alternative operations are possible consistent with this disclosure.

### Example Communications Devices

FIG. 10 depicts aspects of an example communications device 1000. In some aspects, communications device 1000 is a user equipment, such as UE 104 described above with respect to FIGS. 1 and 3.

The communications device 1000 includes a processing system 1005 coupled to a transceiver 1085 (e.g., a transmitter and/or a receiver). The transceiver 1085 is configured to transmit and receive signals for the communications device 1000 via an antenna 1090, such as the various signals as described herein. The processing system 1005 may be configured to perform processing functions for the communications device 1000, including processing signals received and/or to be transmitted by the communications device 1000.

The processing system 1005 includes one or more processors 1010. In various aspects, the one or more processors 1010 may be representative of one or more of receive processor 358, transmit processor 364, TX MIMO processor 366, and/or controller/processor 380, as described with respect to FIG. 3. The one or more processors 1010 are coupled to a computer-readable medium/memory 1045 via a bus 1080. In certain aspects, the computer-readable medium/memory 1045 is configured to store instructions (e.g., computer-executable code), including code 1050-1075, that when executed by the one or more processors 1010, enable and cause the one or more processors 1010 to perform the method 800 described with respect to FIG. 8, or any aspect related to it, including any operations described in relation to FIG. 8. Note that reference to a processor performing a function of communications device 1000 may include one or more processors performing that function of communications device 1000, such as in a distributed fashion.

In the depicted example, computer-readable medium/memory 1045 stores code for obtaining 1050, code for communicating 1055, code for refraining 1060, code for monitoring 1065, code for extending 1070, and code for pausing 1075. Processing of the code 1050-1075 may enable and cause the communications device 1000 to perform the method 800 described with respect to FIG. 8, or any aspect related to it.

The one or more processors 1010 include circuitry configured to implement (e.g., execute) the code (e.g., executable instructions) stored in the computer-readable medium/memory 1045, including circuitry for obtaining 1015, circuitry for communicating 1020, circuitry for refraining 1025, circuitry for monitoring 1030, circuitry for extending 1035, and circuitry for pausing 1040. Processing with circuitry 1015-1040 may enable and cause the communications device 1000 to perform the method 800 described with respect to FIG. 8, or any aspect related to it.

More generally, means for communicating, transmitting, sending or outputting for transmission may include the transceivers 354, antenna(s) 352, transmit processor 364, TX MIMO processor 366, AI processor 370, and/or controller/processor 380 of the UE 104 illustrated in FIG. 3, transceiver 1085 and/or antenna 1090 of the communications device 1000 in FIG. 10, and/or one or more processors 1010 of the communications device 1000 in FIG. 10. Means for communicating, receiving, obtaining, or monitoring may include the transceivers 354, antenna(s) 352, receive processor 358, AI processor 370, and/or controller/processor 380 of the UE 104 illustrated in FIG. 3, transceiver 1085 and/or antenna 1090 of the communications device 1000 in FIG. 10, and/or one or more processors 1010 of the communications device 1000 in FIG. 10. For example, means for refraining, means for refraining, means for monitoring, means for extending, and/or means for pausing may include the controller/processor 380 of the UE 104 illustrated in FIG. 3, and/or one or more processors 1010 of the communications device 1000 in FIG. 10.

FIG. 11 depicts aspects of an example communications device 1100. In some aspects, communications device 1100 is a network entity, such as BS 102 of FIGS. 1 and 3, or a disaggregated base station as discussed with respect to FIG. 2.

The communications device 1100 includes a processing system 1105 coupled to a transceiver 1155 (e.g., a transmitter and/or a receiver) and/or a network interface 1165. The transceiver 1155 is configured to transmit and receive signals for the communications device 1100 via an antenna 1160, such as the various signals as described herein. The network interface 1165 is configured to obtain and send signals for the communications device 1100 via communications link(s), such as a backhaul link, midhaul link, and/or fronthaul link as described herein, such as with respect to FIG. 2. The processing system 1105 may be configured to perform processing functions for the communications device 1100, including processing signals received and/or to be transmitted by the communications device 1100.

The processing system 1105 includes one or more processors 1110. In various aspects, one or more processors 1110 may be representative of one or more of receive processor 338, transmit processor 320, TX MIMO processor 330, and/or controller/processor 340, as described with respect to FIG. 3. The one or more processors 1110 are coupled to a computer-readable medium/memory 1130 via a bus 1150. In certain aspects, the computer-readable medium/memory 1130 is configured to store instructions (e.g., computer-executable code), including code 1135-1145, that when executed by the one or more processors 1110, enable and cause the one or more processors 1110 to perform the method 900 described with respect to FIG. 9, or any aspect related to it, including any operations described in relation to FIG. 9. Note that reference to a processor of communications device 1100 performing a function may include one or more processors of communications device 1100 performing that function, such as in a distributed fashion.

In the depicted example, the computer-readable medium/memory 1130 stores code for sending 1135, code for communicating 1140, and code for obtaining 1145. Processing of the code 1135-1145 may enable and cause the communications device 1100 to perform the method 900 described with respect to FIG. 9, or any aspect related to it.

The one or more processors 1110 include circuitry configured to implement (e.g., execute) the code (e.g., executable instructions) stored in the computer-readable medium/memory 1130, including circuitry for sending 1115, circuitry for communicating 1120, and circuitry for obtaining 1125. Processing with circuitry 1115-1125 may enable and cause the communications device 1100 to perform the method 900 described with respect to FIG. 9, or any aspect related to it.

Various components of the communications device 1100 may provide means for performing the method 900 described with respect to FIG. 9, or any aspect related to it. Means for communicating, transmitting, sending or outputting for transmission may include the transceivers 332, antenna(s) 334, transmit processor 320, TX MIMO processor 330, AI processor 318, and/or controller/processor 340 of the BS 102 illustrated in FIG. 3, transceiver 1155, antenna 1160, and/or network interface 1165 of the communications device 1100 in FIG. 11, and/or one or more processors 1110 of the communications device 1100 in FIG. 11. Means for communicating, receiving or obtaining may include the transceivers 332, antenna(s) 334, receive processor 338, AI processor 318, and/or controller/processor 340 of the BS 102 illustrated in FIG. 3, transceiver 1155, antenna 1160, and/or network interface 1165 of the communications device 1100 in FIG. 11, and/or one or more processors 1110 of the communications device 1100 in FIG. 11.

### Example Clauses

Implementation examples are described in the following numbered clauses:

Clause 1: A method for wireless communications by an apparatus comprising: obtaining a first configuration for cell discontinuous communications, wherein the first configuration indicates (i) a first time period during which communication via a first cell is allowed and (ii) a second time period during which communication via the first cell is unavailable; obtaining a second configuration that indicates one or more measurement occasions for reference signal measurement, wherein the one or more measurement occasions comprise at least one first measurement occasion that overlaps in time with the first time period and at least one second measurement occasion that overlaps in time with the second time period; obtaining an indication of one or more rules for reference signal measurement during a measurement occasion that overlaps in time with a time period during which communication via the first cell is allowed; and communicating with a network entity based on the first configuration, the second configuration, and the one or more rules.

Clause 2: The method of Clause 1, wherein: the one or more rules indicate to prioritize communication via the first cell over reference signal measurement; and communicating with the network entity comprises refraining from monitoring for one or more first reference signals in the at least one first measurement occasion, monitoring for one or more second reference signals in the at least one second measurement occasion, and communicating signaling with the network entity during the first time period.

Clause 3: The method of Clause 2, wherein the one or more rules further indicate a third time period during which communication via the first cell is prioritized over reference signal measurement.

Clause 4: The method of any one of Clauses 1-3, wherein: the one or more rules indicate to prioritize reference signal measurement over communication via the first cell; and communicating with the network entity comprises obtaining one or more reference signals in the at least one first measurement occasion.

Clause 5: The method of Clause 4, wherein the one or more rules indicate a third time period during which reference signal measurement is prioritized over communication via the first cell.

Clause 6: The method of any one of Clauses 1-5, wherein: the one or more rules indicate to prioritize communication via the first cell over reference signal measurement during the measurement occasion that overlaps with the time period during which communication via the first cell is allowed when an interruption time of the measurement occasion occurs within a time window from the time period; and communicating with the network entity comprises refraining from monitoring for one or more reference signals in the at least one first measurement occasion based on occurrence of a first interruption time of the at least one first measurement occasion within the time window from the first time period.

Clause 7: The method of any one of Clauses 1-6, wherein: the one or more rules indicate to extend the time period to fully overlap in time with the measurement occasion when the time period partially overlaps in time with the measurement occasion; and communicating with the network entity comprises extending the first time period to fully overlap in time with the at least one first measurement occasion based on partial overlap in time of the first time period with the at least one first measurement occasion, and refraining from monitoring for one or more reference signals in the at least one first measurement occasion during the first time period.

Clause 8: The method of any one of Clauses 1-7, wherein: the one or more rules indicate to pause a timer that defines an end time of the time period when the measurement occasion partially overlaps in time with the time period; and communicating with the network entity comprises pausing the timer based on partial overlap in time of the at least one first measurement occasion with the first time period such that the first time period fully overlaps in time with the at least one first measurement occasion, and refraining from monitoring for one or more reference signals in the at least one first measurement occasion during the first time period.

Clause 9: The method of any one of Clauses 1-8, wherein: the one or more rules indicate to perform reference signal measurement for a neighbor cell during at least one measurement occasion that overlaps in time with at least one time period during which communication via the first cell is unavailable; and communicating with the network entity comprises refraining from monitoring for one or more first reference signals in the at least one first measurement occasion during the first time period, and obtaining one or more second reference signals via a second cell in the at least one second measurement occasion during the second time period.

Clause 10: The method of any one of Clauses 1-9, further comprising obtaining an indication to activate the first configuration; and communicating with the network entity comprises communicating with the network entity based on the one or more rules after a third time period from communication of the indication to activate the first configuration.

Clause 11: The method of any one of Clauses 1-10, wherein: the first configuration indicates that the first time period and the second time period are part of a periodic cycle associated with cell discontinuous communications; and the second configuration indicates that the one or more measurement occasions occur according to a periodicity.

Clause 12: A method for wireless communications by an apparatus comprising: sending a first configuration for cell discontinuous communications, wherein the first configuration indicates (i) a first time period during which communication via a first cell is allowed and (ii) a second time period during which communication via the first cell is unavailable; sending a second configuration that indicates one or more measurement occasions for reference signal measurement, wherein the one or more measurement occasions comprise at least one first measurement occasion that overlaps in time with the first time period and at least one second measurement occasion that overlaps in time with the second time period; sending an indication of one or more rules for reference signal measurement during a measurement occasion that overlaps in time with a time period during which communication via the first cell is allowed; and communicating with a user equipment based on the first configuration, the second configuration, and the one or more rules.

Clause 13: The method of Clause 12, wherein: the one or more rules indicate to prioritize communication via the first cell over reference signal measurement; and communicating with the user equipment comprises communicating signaling with the user equipment during the first time period.

Clause 14: The method of Clause 13, wherein the one or more rules further indicate a third time period during which communication via the first cell is prioritized over reference signal measurement.

Clause 15: The method of any one of Clauses 12-14, wherein: the one or more rules indicate to prioritize reference signal measurement over communication via the first cell; and communicating with the user equipment comprises sending one or more reference signals in the at least one first measurement occasion.

Clause 16: The method of Clause 15, wherein the one or more rules indicate a third time period during which reference signal measurement is prioritized over communication via the first cell.

Clause 17: The method of any one of Clauses 12-16, wherein the one or more rules indicate to prioritize communication via the first cell over reference signal measurement during the measurement occasion that overlaps with the time period during which communication via the first cell is allowed when an interruption time of the measurement occasion occurs within a time window from the time period.

Clause 18: The method of any one of Clauses 12-17, wherein the one or more rules indicate to extend the time period to fully overlap in time with the measurement occasion when the time period partially overlaps in time with the measurement occasion.

Clause 19: The method of any one of Clauses 12-18, wherein the one or more rules indicate to pause a timer that defines an end time of the time period when the measurement occasion partially overlaps in time with the time period.

Clause 20: The method of any one of Clauses 12-19, wherein: the one or more rules indicate to perform reference signal measurement for a neighbor cell during at least one measurement occasion that overlaps in time with at least one time period during which communication via the first cell is unavailable; and communicating with the user equipment comprises sending one or more second reference signals via a second cell in the at least one second measurement occasion during the second time period.

Clause 21: The method of any one of Clauses 12-20, further comprising obtaining an indication to activate the first configuration; and communicating with the user equipment comprises communicating with the user equipment based on the one or more rules after a third time period from communication of the indication to activate the first configuration.

Clause 22: The method of any one of Clauses 12-21, wherein: the first configuration indicates that the first time period and the second time period are part of a periodic cycle associated with cell discontinuous communications; and the second configuration indicates that the one or more measurement occasions occur according to a periodicity.

Clause 23: One or more apparatuses, comprising: one or more memories comprising executable instructions; and one or more processors configured to execute the executable instructions and cause the one or more apparatuses to perform a method in accordance with any one of Clauses 1-22.

Clause 24: One or more apparatuses, comprising: one or more memories; and one or more processors, coupled to the one or more memories, configured to cause the one or more apparatuses to perform a method in accordance with any one of Clauses 1-22.

Clause 25: One or more apparatuses, comprising: one or more memories; and one or more processors, coupled to the one or more memories, configured to perform a method in accordance with any one of Clauses 1-22.

Clause 26: One or more apparatuses, comprising means for performing a method in accordance with any one of Clauses 1-22.

Clause 27: One or more non-transitory computer-readable media comprising executable instructions that, when executed by one or more processors of one or more apparatuses, cause the one or more apparatuses to perform a method in accordance with any one of Clauses 1-22.

Clause 28: One or more computer program products embodied on one or more computer-readable storage media comprising code for performing a method in accordance with any one of Clauses 1-22.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an ASIC, a field programmable gate array (FPGA) or other programmable logic device (PLD), discrete gate or transistor logic, discrete hardware components, or any combination thereof designed to perform the functions described herein. A general purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “a controller,” “a memory,” “a transceiver,” “an antenna,” “the processor,” “the controller,” “the memory,” “the transceiver,” “the antenna,” etc.), unless otherwise specifically stated, should be understood to refer to one or more elements (e.g., “one or more processors,” “one or more controllers,” “one or more memories,” “one more transceivers,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus configured for wireless communications, comprising:
one or more memories; and
one or more processors coupled to the one or more memories, the one or more processors being configured to cause the apparatus to:
obtain a first configuration for cell discontinuous communications, wherein the first configuration indicates (i) a first time period during which communication via a first cell is allowed and (ii) a second time period during which communication via the first cell is unavailable;
obtain a second configuration that indicates one or more measurement occasions for reference signal measurement, wherein the one or more measurement occasions comprise at least one first measurement occasion that overlaps in time with the first time period and at least one second measurement occasion that overlaps in time with the second time period;
obtain an indication of one or more rules for reference signal measurement during a measurement occasion that overlaps in time with a time period during which communication via the first cell is allowed; and
communicate with a network entity based on the first configuration, the second configuration, and the one or more rules.

2. The apparatus of claim 1, wherein:
the one or more rules indicate to prioritize communication via the first cell over reference signal measurement; and
to communicate with the network entity, the one or more processors are configured to cause the apparatus to:
refrain from monitoring for one or more first reference signals in the at least one first measurement occasion,
monitor for one or more second reference signals in the at least one second measurement occasion, and
communicate signaling with the network entity during the first time period.

3. The apparatus of claim 2, wherein the one or more rules further indicate a third time period during which communication via the first cell is prioritized over reference signal measurement.

4. The apparatus of claim 1, wherein:
the one or more rules indicate to prioritize reference signal measurement over communication via the first cell; and
to communicate with the network entity, the one or more processors are configured to cause the apparatus to obtain one or more reference signals in the at least one first measurement occasion.

5. The apparatus of claim 4, wherein the one or more rules indicate a third time period during which reference signal measurement is prioritized over communication via the first cell.

6. The apparatus of claim 1, wherein:
the one or more rules indicate to prioritize communication via the first cell over reference signal measurement during the measurement occasion that overlaps with the time period during which communication via the first cell is allowed when an interruption time of the measurement occasion occurs within a time window from the time period; and
to communicate with the network entity, the one or more processors are configured to cause the apparatus to refrain from monitoring for one or more reference signals in the at least one first measurement occasion based on occurrence of a first interruption time of the at least one first measurement occasion within the time window from the first time period.

7. The apparatus of claim 1, wherein:
the one or more rules indicate to extend the time period to fully overlap in time with the measurement occasion when the time period partially overlaps in time with the measurement occasion; and
to communicate with the network entity, the one or more processors are configured to cause the apparatus to:
extend the first time period to fully overlap in time with the at least one first measurement occasion based on partial overlap in time of the first time period with the at least one first measurement occasion, and
refrain from monitoring for one or more reference signals in the at least one first measurement occasion during the first time period.

8. The apparatus of claim 1, wherein:
the one or more rules indicate to pause a timer that defines an end time of the time period when the measurement occasion partially overlaps in time with the time period; and
to communicate with the network entity, the one or more processors are configured to cause the apparatus to:
pause the timer based on partial overlap in time of the at least one first measurement occasion with the first time period such that the first time period fully overlaps in time with the at least one first measurement occasion, and
refrain from monitoring for one or more reference signals in the at least one first measurement occasion during the first time period.

9. The apparatus of claim 1, wherein:
the one or more rules indicate to perform reference signal measurement for a neighbor cell during at least one measurement occasion that overlaps in time with at least one time period during which communication via the first cell is unavailable; and
to communicate with the network entity, the one or more processors are configured to cause the apparatus to:
refrain from monitoring for one or more first reference signals in the at least one first measurement occasion during the first time period, and
obtain one or more second reference signals via a second cell in the at least one second measurement occasion during the second time period.

10. The apparatus of claim 1, wherein:
the one or more processors are configured to cause the apparatus to obtain an indication to activate the first configuration; and
to communicate with the network entity, the one or more processors are configured to cause the apparatus to communicate with the network entity based on the one or more rules after a third time period from communication of the indication to activate the first configuration.

11. An apparatus configured for wireless communications, comprising:
one or more memories; and
one or more processors coupled to the one or more memories, the one or more processors being configured to cause the apparatus to:
send a first configuration for cell discontinuous communications, wherein the first configuration indicates (i) a first time period during which communication via a first cell is allowed and (ii) a second time period during which communication via the first cell is unavailable;
send a second configuration that indicates one or more measurement occasions for reference signal measurement, wherein the one or more measurement occasions comprise at least one first measurement occasion that overlaps in time with the first time period and at least one second measurement occasion that overlaps in time with the second time period;
send an indication of one or more rules for reference signal measurement during a measurement occasion that overlaps in time with a time period during which communication via the first cell is allowed; and
communicate with a user equipment based on the first configuration, the second configuration, and the one or more rules.

12. The apparatus of claim 11, wherein:
the one or more rules indicate to prioritize communication via the first cell over reference signal measurement; and
to communicate with the user equipment, the one or more processors are configured to cause the apparatus to communicate signaling with the user equipment during the first time period.

13. The apparatus of claim 12, wherein the one or more rules further indicate a third time period during which communication via the first cell is prioritized over reference signal measurement.

14. The apparatus of claim 11, wherein:
the one or more rules indicate to prioritize reference signal measurement over communication via the first cell; and
to communicate with the user equipment, the one or more processors are configured to cause the apparatus to send one or more reference signals in the at least one first measurement occasion.

15. The apparatus of claim 14, wherein the one or more rules indicate a third time period during which reference signal measurement is prioritized over communication via the first cell.

16. The apparatus of claim 11, wherein the one or more rules indicate to prioritize communication via the first cell over reference signal measurement during the measurement occasion that overlaps with the time period during which communication via the first cell is allowed when an interruption time of the measurement occasion occurs within a time window from the time period.

17. The apparatus of claim 11, wherein the one or more rules indicate to extend the time period to fully overlap in time with the measurement occasion when the time period partially overlaps in time with the measurement occasion.

18. The apparatus of claim 11, wherein the one or more rules indicate to pause a timer that defines an end time of the time period when the measurement occasion partially overlaps in time with the time period.

19. The apparatus of claim 11, wherein:
the one or more rules indicate to perform reference signal measurement for a neighbor cell during at least one measurement occasion that overlaps in time with at least one time period during which communication via the first cell is unavailable; and
to communicate with the user equipment, the one or more processors are configured to cause the apparatus to send one or more second reference signals via a second cell in the at least one second measurement occasion during the second time period.

20. The apparatus of claim 11, wherein:
the one or more processors are configured to cause the apparatus to obtain an indication to activate the first configuration; and
to communicate with the user equipment, the one or more processors are configured to cause the apparatus to communicate with the user equipment based on the one or more rules after a third time period from communication of the indication to activate the first configuration.
